(19) United States
(12) Patent Application Publication
(10) Pub. No.: US 2011/0135849 A1
(43) Pub. Date: Jun. 9, 2011

(54) MULTILAYERED ELEMENTS, THE PRODUCTION THEREOF AND THE USE THEREOF

(75) Inventors: Juliane Kruesemann, Ludwigshafen (DE); Christian Steinig-Nowakowski, Deidesheim (DE); Ralph Lunkwitz, Neustadt (DE); Juergen Kaczun, Wachenheim (DE); Margit Pfundstein, Weingarten (DE)

(73) Assignee: BASF SE, Ludwigshafen (DE)

(21) Appl. No.: 13/058,369

(22) PCT Filed: Jul. 30, 2009
(86) PCT No.: PCT/EP2009/059897

§ 371 Date: Feb. 10, 2011

(30) Foreign Application Priority Data
Aug. 13, 2008 (EP) 08162314.2

(51) Int. Cl. B32B 15/04; B32B 15/12; B32B 3/10; C09K 19/52; B32B 38/14; B32B 37/14

(52) U.S. Cl. 428/1.1; 428/208; 428/201; 428/196; 156/277; 156/150

(57) ABSTRACT

Multilayered articles comprise
(E) optionally at least one decor layer,
(F) at least one substrate comprising cellulose fibers,
(G) at least one metal-containing layer prepared by a process comprising the steps of
   (c) printing covering layer (D) with a printing formulation comprising at least one metal powder,
   (d) providing with at least one item generating or consuming electric current,
   (e) depositing at least one further metal,
(H) optionally at least one covering layer.

The present invention provides multilayered articles comprising

(A) at least one decor layer,

(B) at least one substrate comprising cellulose fibers,

(C) at least one metal-containing layer prepared by a process comprising the steps of
(a) printing decor layer (A) or a part of decor layer (A) with a printing formulation comprising at least one metal powder,
(b) depositing at least one further metal,

(D) optionally at least one covering layer.

The present invention further provides a process for producing multilayered articles and for the use of multilayered articles of the present invention.

Substrates comprising cellulose fibers are used for many applications in building interiors and in automobiles. Examples of applications for building interiors are panels, floorings, wall coverings and ceilings. Examples of applications for the automotive sector are dashboards and consoles. Such cellulosic substrates are popularly combined with electric lines.

MDF and HDF are particularly suitable substrates comprising cellulose fibers, especially through-colored MDF and through-colored HDF as disclosed in WO 2008/055535.

Lines, for example power lines in the form of wires, are in many cases also mounted behind the cited substrates in particular in order that such lines may be invisible to the eye and safe from mechanical destruction.

However, it has emerged that such lines are very sensitive to electrostatic charge buildups. It is also observed that such systems are difficult to install in that they can be installed by professionals only. Such products are particularly unsuitable for do-it-yourself home improvement markets.

It has been proposed that electric lines be printed together with items that consume electric current onto an insulating mat and these insulating mats be laid underneath all common floors. However, such an approach is very costly in manufacture and can lead to slippage-prone substrates.

It is an object of the present invention to provide a flexible system whereby current-consuming or current-generating items can be installed in building interiors or automobiles, for example, and yet be efficiently concealed.

We have found that this object is achieved by the multilayered articles defined at the beginning, which are herein also referred to as inventive articles.

In one embodiment of the present invention, inventive articles comprise at least one decor layer (A). Decor layer (A) may be composed of one or more individual layers.

Decor layer (A) can have one or more parts. In one embodiment of the present invention, decor layer (A) comprises a layered product (overlay paper). In another embodiment of the present invention, decor layer (A) comprises a decor paper. In another embodiment of the present invention, decor layer (A) comprises a wax, oil or paint layer.

Layered products or overlay papers herein are resin-impregnated paper layers composed of two or more plies and molded together by pressure, and the topmost layer of paper may preferably be provided with a motif such as for example wood, metallic or marble. The topmost layer of paper may be protected against mechanical actions by a transparent overlay, for example by a transparent film or sheet of plastic. Useful resins include for example phenolic resins, phenol-formaldehyde resins and melamine resins, also melamine-formaldehyde resins and urea-melamine-formaldehyde resins.

One embodiment of the present invention comprises layered products which are transparent.

Decor paper may comprise for example decoratively styled paper. Decor paper preferably comprises printed paper, predominantly provided with wood structure imitations such as for example beech or maple, or else coating materials printed with a solid color. The printed paper is impregnated with melamine resin and pressed together with a resin-impregnated overlay and likewise resin-impregnated backer paper onto the core under heat and pressure. In direct coating, the four plies—backer, core, decor paper and overlay—are pressed together in one step.

In one embodiment of the present invention, decor layer (A) comprises textile. When textile is chosen as decor layer (A), it is preferable for the textile to be impregnated with a resin, which may be as defined hereinbelow, and cured. The term “textile” is defined hereinbelow and also comprises non-wovens.

Substrates comprising cellulose fibers and herein also referred to as substrates (B) may comprise any desired substrates comprising cellulose fibers, in which case lignocellulose is subsumed under the term cellulose. Examples are paper and paperboard. Preferably, however, substrates comprising cellulose fibers comprise substrates not nondestructively bendable by hand. Examples are woodbase materials such as for example wood, wood plastic composites (WPCs), and particularly woodchip materials such as chipboard, particleboard, fiberboard such as for example oriented strand board (OSB), medium density fiberboard (MDF) and high density fiberboard (HDF).

Wood plastic composites may comprise for example conjointly extruded composites produced from cellulose fibers or lignocellulosic fibers. Examples are fibers of flax, sisal, hemp, coir, of abaca (known as Manila hemp), or else rice spelt, bamboo, straw and peanut shells. Wood fibers are preferred examples of cellulose fibers. Wood fibers may comprise fibers of virgin wood or of reclaimed wood. Wood fibers may further comprise fibers from different wood species such as softwoods from, for example, spruce trees, fir trees, pine trees or larch trees or hardwoods from, for example, beech trees and oak trees. Wastewood such as for example shavings, chips or sawdust are also suitable. Wood composition can vary in its constituents such as cellulose, hemicellulose and lignin.

Wood plastic composites further comprise at least one thermoplastic. Thermoplastics are selected from any desired thermoplastically deformable polymers, which can be new or recyclate from post-use thermoplastic polymers. Thermoplastic is preferably selected from polyolefins, preferably polyethylene, in particular HDPE, polypropylene, in particular isotactic polypropylene, and polyvinyl chloride (PVC), in particular unplaticized PVC, also polyvinyl acetate or mixtures of polyethylene and polypropylene.

The terms polyethylene and polypropylene each also include copolymers of ethylene and propylene respectively with one or more α-olefin or styrene. Thus, polyethylene herein also comprises copolymers which, as well as ethylene as principal monomer (at least 50% by weight), comprise in copolymerized form one or more comonomers selected from styrene or α-olefins such as, for example propylene, 1-butene, 1-hexene, 4-methyl-1-pentene, 1-octene, 1-decene, 1-dodecene, n-α-C₂₂H₄₄, n-α-C₂₄H₄₈ and n-α-C₂₀H₄₀. Polypropylene herein also comprises copolymers which, as well as propylene as principal monomer (at least 50% by weight) comprise in copolymerized form one or more comonomers selected from styrene, ethylene, 1-butene, 1-hexene, 4-methyl-1-pentene, 1-octene, 1-decene, 1-dodecene, n-α-C₂₂H₄₄, n-α-C₂₄H₄₈ and n-α-C₂₀H₄₀.

Wood plastic composites may comprise further components, for example one or more waxes, in particular ethylene copolymer waxes, also stabilizers and one or more colorants, for example pigments.

One embodiment of the present invention comprises selecting substrate (B) from MDF and HDF.

HDF and MDF comprise woodbase materials produced by pressing at elevated temperatures of wood fibers mixed with binders. HDF is herein also referred to as HDF board, and MDF also as MDF board.

One embodiment of the present invention utilizes MDF having a density in the range from 600 to 850 kg/m³ or HDF having a density in the range from 800 to 1100 kg/m³. This invention preferably utilizes HDF having a density in the range from 800 to 1100 kg/m³ as substrate (B).

Wood fibers are obtainable from various raw materials known to one skilled in the art, for example from chips of debarked softwood, but also of debarked hardwoods such as for example beech wood, also from slabs (slab wood), left-over rolls from peeled veneer manufacturer, remnants from veneer manufacture, shavings or reclaimed wood, for example broken pallets. Wood fibers are also obtainable from two or more of the aforementioned raw materials. After various destructurizing and comminuting steps, the destructurized raw materials may be finely milled in a refiner. The wood fibers obtained are dried in blow-line stream dryers usually heated directly with combustion gases or burners. To produce fiberboard, the wood fibers thus obtained are mixed with one or more binders, which is also referred to as resination. This resination can take place in mixers, for example in a drum mixer, or in dryers, for example in a stream dryer. The resinated wood fibers subsequently pass through a dryer in which they are dried to residual moisture contents in the range from 7 to 13%. After drying in a stream dryer, wood fibers can also be resinated in special mixers. Combinations of stream dryers and mixers are also possible.

Wood fibers can be bleached before or during the production of fiberboard.

Wood fibers are chemically bleached with oxidizing and/or reducing chemicals which destroy the colored concomitants in the wood or render them ineffective. Oxidative bleaching is suitably carried out with for example hydrogen peroxide, ozone, oxygen, salts of hydrohalic acids such as chlorites and salts of organic or inorganic peracids, such as peracetates, percarbonates and perborates, particularly their alkali metal salts, in particular sodium salts, of which the percarbonates and hydrogen peroxide are preferred. Reductive bleaching is suitably carried out with for example reducing sulfur compounds, such as dithionites, disulfites, sulfites or sulfur dioxide, sulfinic acids and salts thereof, in particular the alkali metal salts and particularly the sodium salts, and hydroxy carboxylic acids, such as citric acid and malic acid. Preferred reducing agents are the disulfites and sulfites, in particular sodium bisulfite, and also malic acid and citric acid.

Bleaching is preferably carried out by treating aqueous 5% to 40% by weight wood fiber dispersions continuously in countercurrent towers with aqueous solutions or dispersions of the bleaches at temperatures of 90 to 150° C. and pressures up to 3 bar. Bleaching is typically carried out in the presence of complexing agents, such as EDTA, in order that degradation of the bleaches by transition metal ions may be avoided.

One embodiment of the present invention comprises producing fiberboard by using wood fibers bleached initially oxidatively and then reductively.

It is very particularly preferred to conduct the oxidative bleach with percarbonates or hydrogen peroxide and the reductive bleach with sulfites or malic or citric acid.

The wood fibers are advantageously bleached during fiberboard production. For this purpose, bleaches can be added to the chips during the destructurizing and comminuting steps in the preheater or in the cooker. Complexing agents are preferably also added.

To finalize the fiberboard, the resinated chips or wood fibers are then poured into mats, cold-predensified if desired, and hot pressed into fiberboard at temperatures of 170 to 240° C.

Useful binders include amino resins such as urea-formaldehyde resins, melamine-formaldehyde resins and urea-melamine-formaldehyde resins or phenol-reinforced urea-formaldehyde resins or phenol-reinforced urea-melamine-formaldehyde resins, but also isocyanates, for example diphenylmethane 4,4′-diisocyanate (MDI) in preferably polymeric form, also referred to as PMDI in brief.

After their actual production, MDF and HDF used as substrate (B) can be treated by conventional processes such as sanding for example.

In one embodiment of the present invention, substrate (B) comprises partially colored or preferably through-colored substrates comprising cellulose fiber.

In one preferred embodiment of the present invention, HDF or MDF used as substrate (B) is colored, and it is particularly preferred for HDF or MDF used as substrate (B) to be through-colored. Coloration is preferably effected by adding at least one color-conferring component in the course of the production of the fiberboard. The at least one color-conferring component is present in the wood fiberboard in a concentration which is preferably in the range from 0.001% to 20% by weight, based on bone-dry fiber (absolute dry weight of the fiber), more preferably in the range from 0.01% to 10% by weight, all based on bone-dry fiber. Useful color-conferring components include all dyes, pigments, pigment formulations, colorant preparations and mixtures thereof that are known to one skilled in the art as being suitable for coloration of wood fiber materials.

Color-conferring components can be incorporated in the course of fiberboard manufacture either by being added to the binder or, separately therefrom, being applied atop the wood fibers, or mixed with the wood fibers, before or after resination.

In one preferred embodiment of the present invention, the HDF or MDF used as substrate (B) comprises as color-conferring component at least one pigment and, based on pigment, 0.1% to 10% by weight of at least one dye.

Organic and inorganic pigments and also mixtures of organic and inorganic pigments can be used.

Pigments are preferably in finely divided form. In one embodiment of the present invention, pigments have average particle diameters in the range from 0.1 to 5 μm, in particular in the range from 0.1 to 3 μm and particularly in the range from 0.1 to 1 μm.

Organic pigments are typically organic chromatic or black pigments. Inorganic pigments can be color pigments (chromatic, black and white pigments) or luster pigments.

There now follow examples of suitable organic chromatic pigments:

monoazo pigments, disazo pigments, condensed disazo pigments, anthanthrone pigments, anthraquinone pigments, anthrapyrimidine pigments, quinacridone pigments, quinophthalone pigments, diketopyrrolopyrrole pigments, dioxazine pigments, flavanthrone pigments, indanthrone pigments, isoindoline pigments, isoindolinone pigments, isoviolanthrone pigments, metal complex pigments, perinone pigments, perylene pigments, phthalocyanine pigments, pyranthrone pigments, pyrazoloquinazolone pigments, thioindigo pigments, triarylcarbonium pigments.

Suitable inorganic chromatic pigments are inorganic metal compounds such as metal oxides and sulfides, which may also comprise more than one metal. These inorganic pigments include titanium dioxide (C.I. Pigment White 6), zinc white, pigment grade zinc oxide; zinc sulfide, lithopone; iron oxide black (C.I. Pigment Black 11), iron-manganese black, spinel black (C.I. Pigment Black 27); carbon black (C.I. Pigment Black 7) as white and, respectively, black pigments. Useful chromatic pigments include chromium oxide, chromium oxide hydrate green; chromium green (C.I. Pigment Green 48); cobalt green (C.I. Pigment Green 50); ultramarine green, cobalt blue (C.I. Pigment Blue 28 and 36; C.I. Pigment Blue 72), ultramarine blue, manganese blue, ultramarine violet, cobalt and manganese violet, iron oxide red (C.I. Pigment Red 101), cadmium sulfoselenide (C.I. Pigment Red 108), cerium sulfide (C.I. Pigment Red 265), molybdate red (C.I. Pigment Red 104), ultramarine red, iron oxide brown (C.I. Pigment Brown 6 and 7), mixed brown, spinel and corundum phases (C.I. Pigment Brown 29, 31, 33, 34, 35, 37, 39 and 40), chromium titanium yellow (C.I. Pigment Brown 24), chromium orange; cerium sulfide (C.I. Pigment Orange 75), iron oxide yellow (C.I. Pigment Yellow 42), nickel titanium yellow (C.I. Pigment Yellow 53; C.I. Pigment Yellow 157, 158, 159, 160, 161, 162, 163, 164 and 189), chromium titanium yellow, spinel phases (C.I. Pigment Yellow 119), cadmium sulfide and cadmium zinc sulfide (C.I. Pigment Yellow 37 and 35); chromium yellow (C.I. Pigment Yellow 34), bismuth vanadate (C.I. Pigment Yellow 184).

In one embodiment of the present invention, HDF or MDF used as substrate (B) may comprise one or more luster pigments.

Luster pigments comprise platelet-shaped pigments having a monophasic or polyphasic construction, the color play of which is marked by the interplay of interference, reflection and absorption phenomena. Examples are aluminum platelets and aluminum, iron oxide and mica platelets bearing one or more coats of metal oxides in particular.

In accordance with the present invention, HDF or MDF used as substrate (B) can be colored with a dye. Dyes which are soluble in water or in a water-miscible or water-soluble organic solvent are suitable in particular. Cationic and anionic dyes are suitable in particular, and cationic dyes are preferred.

Suitable cationic dyes come in particular from the di and triarylmethane, xanthene, azo, cyanine, azacyanine, methine, acridine, safranine, oxazine, induline, nigrosine and phenazine series, and dyes from the azo, triarylmethane and xanthene series are preferred.

Specific examples are: C.I. Basic Yellow 1, 2 and 37; C.I. Basic Orange 2; C.I. Basic Red 1 and 108; C.I. Basic Blue 1, 7 and 26; C.I. Basic Violet 1, 3, 4, 10, 11 and 49; C.I. Basic Green 1 and 4; C.I. Basic Brown 1 and 4.

Cationic dyes may also be colorants comprising external basic groups. C.I. Basic Blues 15 and 161 are suitable examples here.

Useful cationic dyes further include the corresponding dyebases used in the presence of solubilizing acidic agents. As examples there may be mentioned: C.I. Solvent Yellow 34; C.I. Solvent Orange 3; C.I. Solvent Red 49; C.I. Solvent Violet 8 and 9; C.I. Solvent Blue 2 and 4; C.I. Solvent Black 7.

Suitable anionic dyes are in particular sulfo-containing compounds from the series of the azo, anthraquinone, metal complex, triarylmethane, xanthene and stilbene series, and dyes from the triarylmethane, azo and metal complex (in particular copper, chromium and cobalt complex) series are preferred.

Specific examples which may be mentioned are: C.I. Acid Yellow 3, 19, 36 and 204; C.I. Acid Orange 7, 8 and 142; C.I. Acid Red 52, 88, 351 and 357; C.I. Acid Violet 17 and 90; C.I. Acid Blue 9, 193 and 199; C.I. Acid Black 194; anionic chromium complex dyes such as C.I. Acid Violet 46, 56, 58 and 65; C.I. Acid Yellow 59; C.I. Acid Orange 44, 74 and 92; C.I. Acid Red 195; C.I. Acid Brown 355 and C.I. Acid Black 52; anionic cobalt complex dyes such as C.I. Acid Yellow 119 and 204, C.I. Direct Red 80 and 81.

Water-soluble dyes are preferred.

As water-solubilizing cations there may be mentioned in particular alkali metal cations, such as Li⁺, Na⁺, K⁺, ammonium and substituted ammonium ions, in particular alkanolammonium ions.

In one preferred embodiment, HDF or MDF used as substrater (B) comprises as color-conferring component at least one pigment and, based on pigment, 0.1% to 10% by weight of at least one dye.

Preferably, dyes used have in each case a hue which is comparable to the respective pigment, since a particularly intensive coloration of the MDF or HDF is obtainable in this way. However, dyes which differ in hue can also be used, making it possible for the coloration to be shaded.

In a particularly preferred embodiment of the present invention, MDF and HDF used for substrate (B) of the multilayered articles of the present invention are colored by means of a liquid colorant preparation. Suitable liquid colorant preparations are described in WO 2004/035276. Liquid colorant preparations may comprise:

i at least one pigment

ii at least one dye

iii at least one dispersant

iv water or a mixture of water and at least one water retainer, and

v optionally further customary constituents for colorant preparations.

Liquid colorant preparations to be used generally comprise from 10% to 70% by weight, preferably from 10% to 60% by weight of pigment, based on the liquid colorant preparation in question.

The amount in which dye is present in the liquid colorant preparation to be used is generally in the range from 0.1% to 25% by weight and preferably in the range from 1% to 20% by weight, all based on pigment. Based on the total weight of the preparation, this corresponds to amounts of generally from 0.01% to 7% by weight and particularly from 0.1% to 5.6% by weight. The liquid colorant preparations to be used preferably have a dispersant content in the range from 1% to 50% by weight and particularly in the range from 1% to 40% by weight, based on liquid colorant preparation.

Useful dyes and pigments for inclusion in liquid colorant preparation are subject to the above recitations for the dyes and pigments to be used.

Particularly suitable dispersants are nonionic and anionic surface-active additives and also mixtures thereof.

Preferred nonionic surface-active additives are based on polyethers in particular.

As well as unmixed polyalkylene oxides, preferably C₂-C₄-alkylene oxides and phenyl-substituted C₂-C₄-alkylene oxides, especially polyethylene oxides, polypropylene oxides and poly(phenylethylene oxides), it is in particular block copolymers, especially polymers which include polypropylene oxide and polyethylene oxide blocks or poly(phenylethylene oxide) and polyethylene oxide blocks, and also random copolymers of these alkylene oxides, which are suitable.

Preferred anionic surface-active additives are based on sulfonates, sulfates, phosphonates or phosphates.

A further important group of anionic surface-active additives is formed by the sulfonates, sulfates, phosphonates and phosphates of the polyethers recited as nonionic additives.

Further suitable anionic surface-active additives are based on water-soluble polymers comprising carboxylate groups. These may be advantageously adapted to the respective application and the respective pigment by adjusting the ratio between polar and apolar moieties.

Water forms the liquid vehicle for the colorant preparations to be used according to the present invention.

The liquid phase of the liquid colorant preparations preferably comprises a mixture of water and a water retainer. Useful water retainers are in particular organic solvents which are high boiling (i.e., generally have a boiling point>100° C. at atmospheric pressure) and hence have a water-retaining action and are soluble in or miscible with water.

Examples of suitable water retainers are polyhydric alcohols, preferably unbranched or branched polyhydric alcohols having 2 to 8, preferably 3 to 6, carbon atoms, such as ethylene glycol, 1,2-propylene glycol, 1,3-propylene glycol, glycerol, erythritol, pentaerythritol, pentitol, such as arabitol, adonitol and xylitol, and hexitols, such as sorbitol, mannitol and dulcitol. Useful water retainers further include for example di-, tri- and tetraalkylene glycols and their monoalkyl (especially C₁-C₆-alkyl and particularly C₁-C₄-alkyl) ethers. Examples which may be mentioned are di-, tri- and tetraethylene glycol, diethylene glycol monomethyl, monoethyl, monopropyl and monobutyl ethers, triethylene glycol monomethyl, monoethyl, monopropyl and monobutyl ethers, di-, tri- and tetra-1,2- and -1,3-propylene glycols and di-, tri- and tetra-1,2- and -1,3-propylene glycol monomethyl, monoethyl, monopropyl and monobutyl ethers.

Liquid colorant preparations generally comprise 10% to 88.95% by weight and preferably 10% to 80% by weight of water or a mixture of water and water retainer. When water is present in a mixture with an organic solvent water retainer, this organic solvent will generally account for 1% to 80% by weight and preferably 1% to 60% by weight of the liquid phase.

Liquid colorant preparations may further comprise admixtures such as biocides, defoamers, antisettling agents and rheological modifiers, the fraction of which can generally be up to 5% by weight, based on liquid colorant preparation.

Liquid colorant preparations are obtainable in various ways. Preferably, the first step is to prepare a pigment dispersion which is then admixed with the dye as a solid or particularly in dissolved form.

Liquid colorant preparations are very useful for coloration of MDF and HDF board.

Liquid colorant preparations can be added to the wood fibers and binder mixture which serves as a basis for MDF and HDF board, in various ways and at various stages of the manufacturing operation; see WO 2008/055535 for further details.

HDF or MDF used as substrate (B) can be through-colored in one shade.

Particularly attractive colored effects are obtainable by mixing differently colored wood fibers and subsequent pressing. This is a way of obtaining for example marbled or spotted fiberboard. Special effects are obtainable by multicolored coloration of the wood fibers. For example, differently colored wood fibers can be pressed in layers. Such effects are also obtainable when only a certain percentage of the wood fibers are colored and the others retain their original color.

Multilayered articles of the present invention further comprise a metal-containing layer (C), which may be continuous or preferably discontinuous. Continuous is to be understood as comprehending uniform. Discontinuous metal-containing layers (C) have metal in at some locations but not at others. Metal may be present in the form of irregular or preferably regular patterns.

In one embodiment of the present invention, metal-containing layer (C) has an average thickness in the range from 10 μm to 1 mm and preferably in the range from 100 to 200 μm.

Metal-containing layer (C) is best described in terms of its method of making. Its method of making comprises a plurality of steps:
(a) printing decor layer (A) or a part of decor layer (A) with a printing formulation comprising at least one metal powder,
(b) depositing at least one further metal.

Covering layer (D) is a layer which can have a decorative effect or a protective effect.

In one embodiment of the present invention, covering layer (D) comprises an overlay, a of one or more resin-impregnated layers of paper, textile or plastics film/sheet.

In one embodiment of the present invention, resin is selected from urea-formaldehyde resins, melamine-formaldehyde resins and urea-melamine-formaldehyde resins or phenol-reinforced urea-formaldehyde resins or phenol-reinforced urea-melamine-formaldehyde resins.

Resin may have added to it one or more curatives, for example ammonium salts of strong organic acids, in particular of sulfonic acids. Ammonium is selected from unsubstituted and preferably substituted ammonium, in particular triethylammonium and morpholinium. The addition of curatives augments the curing of the resin.

In one embodiment of the present invention, covering layer (D) is selected from plastics film/sheet, paper or textile.

Plastics film/sheet is herein understood to be as meaning sheetlike structures composed of synthetic polymer, which can have a thickness of 0.5 μm to 1 mm, preferably 1 μm to 0.5 mm and more preferably up to not more than 0.15 mm.

Plastics film/sheet is preferably bendable by hand, i.e., without aid of a tool.

Synthetic polymers are preferably polyolefins such as polyolefins such as polyethylene and polypropylene, polyester, polyamide, polycarbonate, polyvinyl chloride, polymethyl methacrylate and polystyrene, the reference to polyolefins such as polyethylene and polypropylene being understood to refer to copolymers of ethylene and propylene with olefins such as for example acrylic acid or 1-olefins as well as ethylene homopolymers and propylene homopolymers. Polyethylene for instance is to be understood as meaning in particular ethylene copolymers with 0.1% to below 50% by weight of one or more 1-olefins such as propylene, 1-butene, 1-pentene, 1-hexene, 1-octene, 1-decene or 1-dodecene, of which propylene, 1-butene and 1-hexene are preferred. Polypropylene is to be understood as meaning in particular also propylene copolymers with 0.1% to below 50% by weight of ethylene and/or of one or more 1-olefins such as 1-butene, 1-pentene, 1-hexene, 1-octene, 1-decene, or 1-dodecene, of which ethylene, 1-butene and 1-hexene are preferred. Polypropylene is preferably to be understood as meaning essentially isotactic polypropylene.

Film/sheet of polyethylene can be made of HDPE or LDPE or LLDPE.

Film/sheet of polyamide is preferably derived from nylon-6.

Film/sheet of polyester is preferably that of polybutylene terephthalate and in particular of polyethylene terephthalate (PET).

Film/sheet of polycarbonates is preferably derived from polycarbonates obtained using bisphenol A.

Film/sheet of polyvinyl chloride is film/sheet made of plasticized polyvinyl chloride or unplasticized polyvinyl chloride, with plasticized polyvinyl chloride also comprising copolymers of vinyl chloride with vinyl acetate and/or acrylates.

Covering layer comprises textile with particular preference. Textile is used in the realm of the present invention as a textile fabric, for example as a knit or preferably as a woven fabric or as a non-woven. Textile for the purposes of the present invention can be flexible or stiff. Textile preferably comprises such textile fabrics as are bendable one or more times, for example by hand, without any visual difference being observable between before bending and after recovery from the bent state.

Textile for the purposes of the present invention may be composed of natural fibers or synthetic fibers or mixtures of natural fibers and synthetic fibers. Useful natural fibers include for example wool, flax and preferably cotton. Useful synthetic fibers include for example polyamide, polyester, modified polyester, polyester blend fabric, polyamide blend fabric, polyacrylonitrile, triacetate, acetate, polycarbonate, polypropylene, polyvinyl chloride, polyester microfibers, preference being given to polyester and mixtures of cotton with synthetic fibers, in particular mixtures of cotton and polyester.

Layer (C) is produced by printing decor layer (A) or a part of decor layer (A) in step (a) with a printing formulation, preferably an aqueous printing formulation, comprising at least one metal powder, the metal in question having a more strongly negative standard potential than hydrogen in the electrochemical series of the elements.

Examples of printing formulations are nonjettable printing inks, for example gravure printing inks, flexographic printing inks, offset printing inks, letterpress printing inks, jettable printing inks such as for example inks for the Valvoline process or the ink jet process. Preference is given to print pastes, preferably aqueous print pastes.

Metal powder from printing formulation of step (a) is herein also referred to in brief as metal powder (a).

Metal powder (a) can be selected for example from pulverulent Zn, Ni, Cu, Ag, Sn, Co, Mn, Fe, Mg, Pb, Cr and Bi, for example pure or as mixtures or in the form of alloys of the recited metals with each other or with other metals. Examples of suitable alloys are CuZn, CuSn, CuNi, SnPb, SnBi, SnCu, NiP, ZnFe, ZnNi, ZnCo and ZnMn. Preferred metal powders (a) comprise just one metal, particular preference being given to iron powder and copper powder, and very particular preference to iron powder.

In one embodiment of the present invention, metal powder (a) has an average particle diameter in the range from 0.001 to 100 μm, preferably in the range from 0.05 to 50 μm and more preferably in the range from 0.1 to 10 μm (determined by laser diffraction measurement, for example using a Microtrac X100).

In one embodiment, metal powder (a) is characterized by its particle diameter distribution. For example, the d₁₀ value can be in the range from 0.001 to 5 μm, the d50 value in the range from 1 to 10 μm and the d₅₀ value in the range from 3 to 100 μm, subject to the condition: d₁₀<d₅₀<d₉₀. Preferably, no particle has a diameter greater than 100 μm.

Metal powder (a) can be used in passivated form, for example in an at least partially coated form. Examples of suitable coatings include inorganic layers such as oxides of the metal in question, SiO₂/SiO₂.aq or phosphates for example of the metal in question.

The particles of metal powder (a) can in principle have any desired shape in that for example acicular, lamellar or spherical particles can be used; spherical and lamellar particles are preferred.

It is particularly preferable to use metal powders (a) having spherical particles, preferably predominantly having spherical particles, most preferably so-called carbonyl iron powders having spherical particles.

Metal powder (a) can be used in one embodiment of the present invention in admixture with carbon compounds, in particular carbon compounds which consist essentially of carbon, examples being pigment grade carbon blacks. Particular preference is given to electrically conductive carbon compounds such as conductivity grade carbon blacks, carbon nanotubes or graphenes.

Metal powder (a) can be printed in one embodiment of step (a) such that the particles of metal powder are so close together that they are already capable of conducting electricity. In another embodiment of step (a), metal powder (a) can be printed such that the particles of metal powder (a) are so far apart from each other that they are not capable of conducting electricity.

The production of metal powders (a) is known per se. For example, common commercial goods can be used or metal powders (a) can be produced by processes known per se, for example by electrolytic deposition or chemical reduction from solutions of the salts of the metals in question or by reduction of an oxidic powder for example by means of hydrogen, by spraying or jetting a molten metal, in particular into cooling media, for example gasses or water.

Particular preference is given to using such metal powder (a) as was produced by thermal decomposition of iron pentacarbonyl, herein also referred to as carbonyl iron powder.

The production of carbonyl iron powder by thermal decomposition of, in particular, iron pentacarbonyl Fe(CO)₅ is described for example in Ullmann's Encyclopedia of Industrial Chemistry, 5th Edition, Volume A14, page 599. The decomposition of iron pentacarbonyl can be effected for example at atmospheric pressure and for example at elevated temperatures, for example in the range from 200 to 300° C., for example in a heatable decomposer comprising a tube of heat-resistant material such as quartz glass or V2A steel in a preferably vertical position, the tube being surrounded by heating means, for example consisting of heating tapes, heating wires or a heating mantle through which a heating medium flows.

The average particle diameter of carbonyl iron powder can be controlled within wide limits via the process parameters and reaction management in relation to the decomposition stage, and is in terms of the number average in general in the range from 0.01 to 100 μm, preferably in the range from 0.1 to 50 μm and more preferably in the range from 1 to 8 μm.

In one embodiment, a pattern of metal powder (a) is printed in step (a) by printing some areas of decor layer (A), or part of decor layer (A), with printing formulation comprising metal powder (a) and not other areas. Preference is given to printing patterns wherein metal powders (a) are arranged on decor layer (A) or a part of decor layer (A) in the form of straight or preferably bent stripy patterns or line patterns, where the lines mentioned may have for example a width and thickness each in the range from 0.1 μm to 5 mm and the stripes mentioned may have a width in the range from 5.1 mm to for example 10 cm or if appropriate more and a thickness in the range from 0.1 μm to 5 mm.

In one specific embodiment of the present invention, such stripy patterns or line patterns of metal powder (a) are printed wherein the stripes or lines neither touch nor intersect.

In another specific embodiment of the present invention, stripy patterns or line patterns of metal powder (a) are printed wherein the stripes or lines cross, for example if the intention is to manufacture printed circuits.

In one embodiment of the present invention, printing in step (a) is effected by following various processes which are known per se. One embodiment of the present invention utilizes a stencil through which the printing formulation comprising metal powder (a) is pressed using a squeegee. The above-described process is a screen printing process. Further suitable printing processes are gravure printing processes and flexographic printing processes. A further suitable printing process is selected from valve-jet processes. Valve-jet processes utilize such printing formulation as preferably comprises no thickener.

Step (b) of the production of layer (C) comprises depositing at least one further metal. One or more further metals may be deposited in step (b), but it is preferable to deposit just one further metal.

The process of the present invention is carried out by depositing in step (b) a further metal onto decor layer (A) or the relevant part of decor layer (A). “Decor layer (A)” refers to the decor layer (A), or the relevant part of decor layer (A), which have previously been processed by following steps (a) to (e) and if appropriate further steps such as for example (d).

One embodiment of the present invention utilizes carbonyl iron powder as metal powder (a) in step (a) and silver, gold, nickel and particularly copper as further metal in step (b).

In one embodiment of the present invention, hereinafter also referred to as step (b1), no external source of voltage is used in step (b1) and the further metal in step (b1) has a more strongly positive standard potential in the electrochemical series of the elements, in alkaline or preferably in acidic solution, than metal underlying metal powder (a) and than hydrogen.

One possible procedure is for example for decor layer (A), or part of decor layer (A), printed in step (a) and, if appropriate, provided with electric items in a step (c), to be treated with a basic, neutral or preferably acidic preferably aqueous solution of salt of further metal and if appropriate one or more reducing agents, for example by placing it into the solution in question.

One embodiment of the present invention comprises treating in step (b1) for from 0.5 minutes to 12 hours, preferably up to 30 minutes.

One embodiment of the present invention comprises treating in step (b1) with a basic, neutral or preferably acidic solution of salt of further metal, the solution having a temperature in the range from 0 to 100° C., preferably 10 to 80° C.

One or more reducing agents may additionally be added in step (b1). When, for example, copper is chosen as further metal, possible reducing agents added include for example aldehydes, in particular reducing sugars or formaldehyde as reducing agent. When, for example, nickel is chosen as further metal, examples of reducing agents which can be added include alkali metal hypophosphite, in particular NaH₂PO₂.2H₂O, or boranates, in particular NaBH₄.

In another embodiment, hereinafter also referred to as step (b2), of the present invention, an external source of voltage is used in step (b2) and the further metal in step (b2) can have a more strongly or more weakly positive standard potential in the electrochemical series of the elements in acidic or alkaline solution than metal underlying metal powder (a). Preferably, carbonyl iron powder may be chosen for this as metal powder (a) and nickel, zinc or particularly copper as further metal. In the event that the further metal in step (b2) has a more strongly positive standard potential in the electrochemical series of the elements than hydrogen and than metal underlying metal powder (a) it is observed that additionally further metal is deposited analogously to step (b1).

Step (b2) may be carried out for example by applying a current having a strength in the range from 10 to 100 A, preferably in the range from 12 to 50 A.

One version of step (b2) utilizes a current density in the range from 0.05 to 50 A/dm², preferably 0.1 to 30 A/dm².

Step (b2) can be carried out for example by using an external source of voltage for a period in the range from 10 minutes to 160 hours.

In one embodiment of the present invention, step (b1) and step (b2) are combined b_{y} initially operating without and then with an external source of voltage and the further metal in step (b) having a more strongly positive standard potential in the electrochemical series of the elements than metal underlying metal powder (a).

One embodiment of the present invention comprises adding one or more auxiliary materials to the solution of further metal. Examples of useful auxiliary materials include buffers, surfactants, polymers, in particular particulate polymers whose particle diameter is in the range from 10 nm to 10 μm, defoamers, one or more organic solvents, one or more complexing agents.

Acetic acid/acetate buffers are particularly useful.

Particularly suitable surfactants are selected from cationic, anionic and in particular nonionic surfactants.

As cationic surfactants there may be mentioned for example: C₆-C₁₈-alkyl-, -aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the Gemini surfactant N,N′-(lauryldimethyl)ethylenediamine dibromide.

Examples of suitable anionic surfactants are alkali metal and ammonium salts of alkyl sulfates (alkyl radical: C₈ to C₁₂), of acid sulfuric esters of ethoxylated alkanols (degree of ethoxylation: 4 to 30, alkyl radical: C₁₂-C₁₈) and of ethoxylated alkylphenols (degree of ethoxylation: 3 to 50, alkyl radical: C₄-C₁₂), of alkylsulfonic acids (alkyl radical: C₁₂-C₁₈), of alkylarylsulfonic acids (alkyl radical: C₉-C₁₈) and of sulfosuccinates such as for example sulfosuccinic mono- or diesters. Preference is given to aryl- or alkyl-substituted polyglycol ethers and also substances described in U.S. Pat. No. 4,218,218, and homologs with y (from the formulae of U.S. Pat. No. 4,218,218) in the range from 10 to 37.

Particular preference is given to nonionic surfactants such as for example singly or preferably multiply alkoxylated C₁₀-C₃₀-alkanols, preferably oxo process or fatty alcohols alkoxylated with three to one hundred mol of C₂-C₄-alkylene oxide, in particular ethylene oxide.

Suitable defoamers are for example siliconic defoamers such as for example those of the formula HO—(CH₂)₃—Si(CH₃)[OSi(CH₃)₃]₂ and HO—(CH₂)₃—Si(CH₃)[OSi(CH₃)₃][OSi(CH₃)₂OSi(CH₃)₃], nonalkoxylated or alkoxylated with up to 20 equivalents of alkylene oxide and particularly ethylene oxide. Silicone-free defoamers are also suitable, examples being multiply alkoxylated alcohols, for example fatty alcohol alkoxylates, preferably 2- to 50-tuply ethoxylated preferably unbranched C₁₀-C₂₀-alkanols, unbranched C₁₀-C₂₀-alkanols and 2-ethylhexan-1-ol. Further suitable defoamers are fatty acid C₈-C₂₀-alkyl esters, preferably C₁₀-C₂₀-alkyl stearates, in which C₈-C₂₀-alkyl and preferably C₁₀-C₂₀-alkyl may be branched or unbranched.

Suitable complexing agents are such compounds as form chelates. Preference is given to such complexing agents as are selected from amines, diamines and triamines bearing at least one carboxylic acid group. Suitable examples are nitrilotriacetic acid, ethylenediaminetetraacetic acid and diethylenepentaaminepentaacetic acid and also the corresponding alkali metal salts.

One embodiment of the present invention comprises depositing sufficient further metal so as to produce a layer thickness in the range from 100 nm to 500 μm, preferably in the range from 1 μm to 100 μm and more preferably in the range from 2 μm to 50 μm.

Step (b) is carried out by metal powder (a) being in most cases partially or completely replaced by further metal, in which case the morphology of further deposited metal need not be identical to the morphology of metal powder (a).

On completion of the deposition of further metal (b), layer (C) is obtained on decor layer (A), or part of decor layer (A), which in either case can be rinsed, for example with water, one or more times.

In one embodiment of the present invention, layer (C) may be prepared by a process further comprising as step
(c) providing with at least one item generating or consuming electric current, after the deposition of further metal (b) or preferably after the printing as per step (a), but before the depositing with further metal (b). The providing with at least one item which generates or consumes electric current is also referred to in brief as step (c).

In step (c), the decor layer (A) printed with metal powder (a), or a part of the decor layer (A) printed with metal powder (a), is provided with at least one item which generates or consumes electric current, herein also referred to in brief as electric item. Preference is given to providing with at least two electric items, more preferably with from 2 to 50.

One embodiment of step (c) comprises fixing the electric item or items to decor layer (A) or the relevant part of decor layer (A).

One embodiment of the present invention comprises fixing in step (c) at least one item requiring or generating electric current at two or more locations at which formulation comprising metal powder (a) was applied in step (a).

“Two or more locations” shall for the purposes of the present invention refer to such locations of the pattern from step (a) as comprise metal powder (a) or deposited metal from step (b).

In one embodiment of the present invention, any two of the locations printed in step (a) and to which at least one electric item is fixed in step (c) belong to different parts, for example stripes, of the pattern printed in step (a).

Preferably, any two of the locations specified in step (c) are close together, for example in the range from 0.1 to 5 mm, preferably up to 2 mm.

In one embodiment of the present invention, the electric items fixed in step (c) are relatively small, for example having an average diameter in the range from 1 to 5 mm, or less.

In another version of the present invention, items fixed in step (c) comprise sensors which can be used as proximity sensors and which have dimensions in the range from 1 to 10 cm (length and width) and also 1 to 5 mm, preferably up to 2 mm (thickness).

In many cases, electric items fixed in step (c) have an average thickness in the range from 0.1 to 5 mm.

In one embodiment of the present invention, electric items have at least two terminals. of which one is fixed at the abovementioned location.

Electric items may be different in kind or the same.

One embodiment of the present invention selects electric items from light-emitting diodes, liquid crystal display elements, Peltier elements, transistors, electrochrome dyes, resistive elements, capacitive elements, inductive elements, diodes, transistors, actuators, electromechanical elements and solar cells.

Light-emitting diodes, liquid crystal display elements, Peltier elements, transistors, electrochrome dyes, resistive elements, capacitive elements, inductive elements, diodes, transistors, actuators, electromechanical elements and solar cells are known as such and are commercially available.

In one embodiment of the present invention, the fixing of electric items is carried out in conventional mounting processes and systems. Examples of mounting processes and systems are known from circuit board manufacture for example (surface mount technology). Automatic placement machines place for example one or more electric items at the particular desired location of the decor layer (A) printed according to step (a) or of the relevant part of decor layer (A).

One embodiment of the present invention, where sufficiently small electric items are to be fixed, proceeds from electric items packed in belts of cardboard or plastic. The belts have pockets holding the electric items. The upper surface of the pocket is sealed for example by a film which can be peeled off to remove the electric items. The belts themselves are wound up on a roll. On at least one side, the roll has holes at regular intervals by which the belt can be forwarded by the automatic placement machine. These rolls are fed to the automatic placement machine by means of feeders. The electric items are removed for example with vacuum tweezers or grippers and then placed in the desired position of the textile substrate. This operation is repeated for all electric items to be fixed.

To produce for example such inventive metalized multilayered articles as are to be used for producing display means, power leads can additionally be attached, for example by soldering, at the ends in a conventional manner.

In one embodiment of the present invention layer (C) is prepared by a process further comprising as step
(d) at least one thermal treatment.

The thermal treatment (d) is preferably carried out by warming or heating in a dry medium, for example in a gas stream.

A final step of producing inventive multilayered articles may comprise pressing the various layers together. This can be done for example by pressing together at a pressure in the range from 10 to 80 bar, preferably 20 to 50 bar.

One embodiment of the present invention comprises pressing at a temperature in the range from 120 to 220° C., preferably 150 to 220° C.

One embodiment of the present invention comprises pressing for a period in the range from 10 seconds to several minutes, for example up to 10 minutes, preferably 20 seconds to one minute.

Instead of pressing under the aforementioned conditions, the various layers can also be adhered together using adhesives known per se. When it is desired to use adhesive to bond the various layers together, it can be sensible to press the layers together.

Inventive multilayered articles have excellent properties. They are mechanically workable, for example by milling, drilling, sawing, and edges and profiles can be cut as with genuine wood. Inventive multilayered articles can be adhered together and be assembled to form larger elements and coverings.

When inventive multilayered articles are provided with tongues and grooves, they can be processed into panels which are easy to install in the manner of T&G panels.

Inventive multilayered articles produced using MDF or HDF may comprise an additional layer (E), which serves as backer and can also be called backer (E). The additional layer (E) can be made of any material known for this purpose in that, for example, the backer (E) can be a paper which is impregnated with melamine resin and which is pressed onto the underside of the HDF or MDF board.

Inventive multilayered articles produced using MDF or HDF optionally comprise a protective layer which serves as face layer and is also known as overlay, on printed decor layer (A) or particularly on printed part of decor layer (A). This protective layer can be a transparent paper which is impregnated with melamine resin and which is pressed onto the top side of the MDF and HDF boards, or can be a melamine resin layer.

When inventive multilayered articles comprise floor panels and when inventive floor panels are to be provided with a protective layer, the backer (E) and the protective layer are preferably applied in one step. Before and after the application of backer (E) and, if appropriate, of the protective layer, the visible side can be worked by embossing, stamping or milling for example so that the visible side acquires a textured surface. The working can be carried out manually or preferably using mechanically controlled machines or using Computerized Numerical Control (CNC) machines. “Living surfaces” can be obtained this way, which come very close to the surface of genuine wood. It is also possible for deepened groove profiles to be milled into the panels.

Inventive multilayered article may be subjected to other surface treatments on its upper surface, also called visible side. In general, any methods and materials known from the surface protection of parquet can be used for treating the visible side of inventive multilayered articles, for example UV-curing coatings, powder coatings and other transparent surface coatings. Prior to any surface treatment, the visible side may be given a three-dimensional texture, for example by embossing, CNC methods, stamping or milling. In a further embodiment of the present invention, the visible side of the inventive multilayered article is only three-dimensionally textured and no further surface treatment is carried out. In another embodiment of the present invention, the visible side of inventive multilayered articles may be sanded, waxed, oiled, pickled, glazed or else painted without application of a further decor layer (A) or of an overlay

Inventive multilayered articles may comprise further layers. For example, footfall sound insulation or thermal insulation may be applied on the underside of inventive multilayered articles.

Inventive multilayered articles can be divided into commercially customary dimensions and be provided with a groove on one longitudinal side and one transverse side and with a tongue which fits into the groove on the respectively opposite longitudinal and transverse sides. This can be done by milling for example.

Inventive multilayered articles can be used for many applications in building interiors and in automobiles. Examples of applications for building interiors are panels, in particular floor panels, also flooring, wall coverings and ceilings. Examples of applications for the automotive sector are dashboards and consoles.

When conductive lines are arranged in patterns in inventive multilayered articles, such patterns are very flexible to modify and supplement.

In addition, inventive multilayered articles are mechanically very robust, display only minimal unwanted self-heating and are insensitive to electrostatic charge buildup or discharge. Furthermore, inventive multilayered articles are easy to install and can easily be handled by the do-it-yourself home improver.

The present invention further provides a process for producing multilayered articles, in particular inventive multilayered articles. The process of the present invention, herein also referred to as inventive production process, comprises the steps of:

providing a decor layer (A) or a part of decor layer (A),
(a) printing with a printing formulation comprising at least one metal powder,
(b) depositing at least one further metal,
(c) optionally providing at least one item which generates or consumes electric current, preferably after the printing of step (a), but before the depositing of step (b),
(d) optionally a thermal treatment,

applying at least one substrate (B) comprising cellulose fibers onto the decor layer (A), or part of decor layer (A), thus provided with a metal-containing layer (C),

the at least one substrate (B) having been or being provided with a covering layer (D).

The various terms are elucidated above.

In one embodiment of the present invention, preferably aqueous printing formulations in step (a) may comprise a binder, preferably at least one aqueous dispersion of at least one filming polymer, for example polyacrylate, polybutadiene, copolymers of at least one vinylaromatic with at least one conjugated diene and if appropriate further comonomers, for example styrene-butadiene binders. Further suitable binders are selected from polyurethane, preferably anionic polyurethane, or ethylene-(meth)acrylic acid copolymer.

Useful binder polyacrylates for the purposes of the present invention are obtainable for example by copolymerization of at least one C₁-C₁₀-alkyl (meth)acrylate, for example methyl acrylate, ethyl acrylate, n-butyl acrylate, n-butyl methacrylate, 2-ethylhexyl acrylate, with at least one further comonomer, for example with a further C₁-C₁₀-alkyl(meth)acrylate, (meth)acrylic acid, (meth)acrylamide, N-methylol(meth)acrylamide, glycidyl(meth)acrylate or a vinylaromatic compound such as styrene for example.

Useful binder polyurethanes for the purposes of the present invention, which are preferably anionic, are obtainable for example by reaction of one or more aromatic or preferably aliphatic or cycloaliphatic diisocyanate with one or more polyesterdiols and preferably one or more hydroxy carboxylic acids, for example hydroxyacetic acid, or preferably dihydroxy carboxylic acids, for example 1,1-dimethylolpropionic acid, 1,1-dimethylolbutyric acid or 1,1-dimethylolethanoic acid.

Particularly useful binder ethylene-(meth)acrylic acid copolymers are obtainable for example by copolymerization of ethylene, (meth)acrylic acid and if appropriate at least one further comonomer such as for example C₁-C₁₀-alkyl(meth)acrylate, maleic anhydride, isobutene or vinyl acetate, preferably by copolymerization at temperatures in the range from 190 to 350° C. and pressures in the range from 1500 to 3500 bar and preferably in the range from 2000 to 2500 bar.

Particularly useful binder ethylene-(meth)acrylic acid copolymers may for example comprise up to 90% by weight of interpolymerized ethylene and have a melt viscosity ν in the range from 60 mm²/s to 10 000 mm²/s, preferably in the range from 100 mm²/s to 5000 mm²/s, measured at 120° C.

Particularly useful binder ethylene-(meth)acrylic acid copolymers may for example comprise up to 90% by weight of interpolymerized ethylene and have a melt flow rate (MFR) in the range from 1 to 50 g/10 min, preferably in the range from 5 to 20 g/10 min and more preferably in the range from 7 to 15 g/10 min, measured at 160° C. under a load of 325 g in accordance with EN ISO 1133.

Particularly useful binder copolymers of at least one vinylaromatic with at least one conjugated diene and if appropriate further comonomers, for example styrene-butadiene binders, comprise at least one ethylenically unsaturated carboxylic acid or dicarboxylic acid or a suitable derivative, for example the corresponding anhydride, in interpolymerized form. Particularly suitable vinylaromatics are para-methylstyrene, α-methylstyrene and especially styrene. Particularly suitable conjugated dienes are isoprene, chloroprene and in particular 1,3-butadiene. Particularly suitable ethylenically unsaturated carboxylic acids or dicarboxylic acids or suitable derivatives thereof are (meth)acrylic acid, maleic acid, itaconic acid, maleic anhydride or itaconic anhydride, to name just some examples.

In one embodiment of the present invention, particularly suitable binder copolymers of at least one vinylaromatic with at least one conjugated diene and if appropriate further comonomers comprise in interpolymerized form:

19.9% to 80% by weight of vinylaromatic,

19.9% to 80% by weight of conjugated diene,

0.1% to 10% by weight of ethylenically unsaturated carboxylic acid or dicarboxylic acid or a suitable derivative, for example the corresponding anhydride.

In one embodiment of the present invention, binder has a dynamic viscosity η at 23° C. in the range from 10 to 100 dPa·s and preferably in the range from 20 to 30 dPa·s, determined for example by rotary viscometry, for example using a Haake viscometer.

Preferably aqueous formulations used in step (a) may comprise one or more emulsifies.

As emulsifier there may be used anionic, cationic or preferably nonionic surface-active substances.

Examples of suitable cationic emulsifiers are for example C₆-C₁₈-alkyl-, -aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)-ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the Gemini surfactant N,N′-(lauryldimethyl)ethylenediamine dibromide.

Examples of suitable anionic emulsifiers are alkali metal and ammonium salts of alkyl sulfates (alkyl radical: C₈ to C₁₂), of acid sulfuric esters of ethoxylated alkanols (degree of ethoxylation: 4 to 30, alkyl radical: C₁₂-C₁₈) and of ethoxylated alkylphenols (degree of ethoxylation: 3 to 50, alkyl radical: C₄-C₁₂), of alkylsulfonic acids (alkyl radical: C₁₂-C₁₈), of alkylarylsulfonic acids (alkyl radical: C₉-C₁₈) and of sulfosuccinates such as for example sulfosuccinic mono- or diesters. Preference is given to aryl- or alkyl-substituted polyglycol ethers and also to substances described in U.S. Pat. No. 4,218,218, and homologs with y (from the formulae of U.S. Pat. No. 4,218,218) in the range from 10 to 37.

Particular preference is given to nonionic emulsifiers such as for example singly or preferably multiply alkoxylated C₁₀-C₃₀ alkanols, preferably oxo process or fatty alcohols alkoxylated with three to one hundred mol of C₂-C₄-alkylene oxide, in particular ethylene oxide.

Examples of particularly suitable multiply alkoxylated fatty alcohols and oxo process alcohols are

n-C₁₈H₃₇O—(CH₂CH₂O)₈₀—H, n-C₁₈H₃₇O—(CH₂CH₂O)₇₀—H, n-C₁₈H₃₇O—(CH₂CH₂O)₆₀—H, n-C₁₈H₃₇O—(CH₂CH₂O)₅₀—H, n-C₁₈H₃₇O—(CH₂CH₂O)₂₅—H, n-C₁₈H₃₇O—(CH₂CH₂O)₁₂—H, n-C₁₆H₃₃O—(CH₂CH₂O)₈₀—H, n-C₁₆H₃₃O—(CH₂CH₂O)₇₀—H, n-C₁₆H₃₃O—(CH₂CH₂O)₆₀—H, n-C₁₆H₃₃O—(CH₂CH₂O)₅₀—H, n-C₁₆H₃₃O—(CH₂CH₂O)₂₅—H, n-C₁₆H₃₃O—(CH₂CH₂O)₁₂—H, n-C₁₂H₂₅O—(CH₂CH₂O)₁₁—H, n-C₁₂H₂₅O—(CH₂CH₂O)₁₈—H, n-C₁₂H₂₅O—(CH₂CH₂O)₂₅—H, n-C₁₂H₂₅O—(CH₂CH₂O)₅₀—H, n-C₁₂H₂₅O—(CH₂CH₂O)₈₀—H, n-C₃₀H₆₁O—(CH₂CH₂O)₈—H, n-C₁₀H₂₁O—(CH₂CH₂O)₉—H, n-C₁₀H₂₁O—(CH₂CH₂O)₇—H, n-C₁₀H₂₁O—(CH₂CH₂O)₅—H, n-C₁₀H₂₁O—(CH₂CH₂O)₃—H,

and mixtures of the aforementioned emulsifiers, for example mixtures of n-C₁₈H₃₇O—(CH₂CH₂O)₅₀—H and n-C₁₆H₃₃O—(CH₂CH₂O)₅₀—H,

the indices each being number averages.

In one embodiment of the present invention, printing formulations used in step (a) can comprise at least one rheology modifier selected from thickeners and viscosity reducers.

Suitable thickeners are for example natural thickeners or preferably synthetic thickeners. Natural thickeners are such thickeners as are natural products or are obtainable from natural products by processing such as purifying operations for example, in particular extraction. Examples of inorganic natural thickeners are sheet silicates such as bentonite for example. Examples of organic natural thickeners are preferably proteins such as for example casein or preferably polysaccharides. Particularly preferred natural thickeners are selected from agar agar, carrageenan, gum arabic, alginates such as for example sodium alginate, calcium alginate, ammonium alginate, calcium alginate and propylene glycol alginate, pectins, polyoses, carob bean flour (carubin) and dextrins.

Preference is given to using synthetic thickeners selected from generally liquid solutions of synthetic polymers, in particular acrylates, in for example white oil or as aqueous solutions, and from synthetic polymers in dried form, for example spray-dried powders. Synthetic polymers used as thickeners comprise acid groups, which are neutralized with ammonia completely or to a certain percentage. In the course of the fixing operation, ammonia is released, reducing the pH and starting the actual fixing process. The pH reduction necessary for fixing may alternatively be effected by adding nonvolatile acids such as for example citric acid, succinic acid, glutaric acid or malic acid.

Very particularly preferred synthetic thickeners are selected from copolymers of 85% to 95% by weight of acrylic acid, 4% to 14% by weight of acrylamide and 0.01 to not more than 1% by weight of the (meth)acrylamide derivative of the formula I

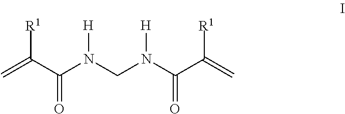

having molecular weights M_{w} in the range from 100 000 to 2 000 000 g/mol, in each of which the R¹ radicals may be the same or different and may represent methyl or hydrogen.

Further suitable thickeners are selected from reaction products of aliphatic diisocyanates such as for example trimethylene diisocyanate, tetramethylene diisocyanate, hexamethylene diisocyanate or 1,12-dodecane diisocyanate with preferably 2 equivalents of multiply alkoxylated fatty alcohol or oxo process alcohol, for example 10 to 150-tuply ethoxylated C₁₀-C₃₀ fatty alcohol or C₁₁-C₃₁ oxo process alcohol.

Suitable viscosity reducers are for example organic solvents such as dimethyl sulfoxide (DMSO), N-methylpyrrolidone (NMP), N-ethylpyrrolidone (NEP), ethylene glycol, diethylene glycol, butylglycol, dibutylglycol and for example alkoxylated n-C₄-C₈-alkanol free of residual alcohol, preferably singly to 10-tuply and more preferably 3- to 6-tuply ethoxylated n-C₄-C₈-alkanol free of residual alcohol. Residual alcohol refers to the respectively nonalkoxylated n-C₄-C₈-alkanol.

In one embodiment of the present invention, the printing formulation used in step (a) comprises

from 10% to 90% by weight, preferably from 50% to 85% by weight and more preferably from 60% to 80% by weight of metal powder (a),

from 1% to 20% by weight and preferably from 2% to 15% by weight of binder,

from 0.1% to 4% by weight and preferably up to 2% by weight of emulsifier,

from 0% to 5% by weight and preferably from 0.2% to 1% by weight of rheology modifier,

weight % ages each being based on the entire printing formulation used in step (a) and relating in the case of binder to the solids content of the respective binder.

One embodiment of the present invention comprises printing in step (a) of the process of the present invention with a printing formulation which, in addition to metal powder (a) and if appropriate binder, if appropriate emulsifier and if appropriate rheology modifier, comprises at least one auxiliary. Examples of suitable auxiliaries are hand improvers, defoamers, wetting agents, leveling agents, urea, actives such as for example biocides or flame retardants:

Suitable defoamers are for example siliconic defoamers such as for example those of the formula HO—(CH₂)₃—Si(CH₃)[OSi(CH₃)₃]₂ and HO—(CH₂)₃—Si(CH₃)[OSi(CH₃)₃][OSi(CH₃)₂OSi(CH₃)₃], nonalkoxylated or alkoxylated with up to 20 equivalents of alkylene oxide and especially ethylene oxide. Silicone-free defoamers are also suitable, examples being multiply alkoxylated alcohols, for example fatty alcohol alkoxylates, preferably 2 to 50-tuply ethoxylated preferably unbranched C₁₀-C₂₀ alkanols, unbranched C₁₀-C₂₀ alkanols and 2-ethylhexan-1-ol. Further suitable defoamers are fatty acid C₈-C₂₀-alkyl esters, preferably C₁₀-C₂₀-alkyl stearates, each of which C₈-C₂₀-alkyl and preferably C₁₀-C₂₀-alkyl may be branched or unbranched.

Suitable wetting agents are for example nonionic, anionic or cationic surfactants, in particular ethoxylation and/or propoxylation products of fatty alcohols or propylene oxide-ethylene oxide block copolymers, ethoxylated or propoxylated fatty or oxo process alcohols, also ethoxylates of oleic acid or alkylphenols, alkylphenol ether sulfates, alkylpolyglycosides, alkyl phosphonates, alkylphenyl phosphonates, alkyl phosphates or alkylphenyl phosphates.

Suitable leveling agents are for example block copolymers of ethylene oxide and propylene oxide having molecular weights Mₙ in the range from 500 to 5000 g/mol and preferably in the range from 800 to 2000 g/mol. Very particular preference is given to block copolymers of propylene oxide-ethylene oxide for example of the formula EO₈PO₇EO₈, where EO represents ethylene oxide and PO represents propylene oxide.

Suitable biocides are for example commercially obtainable as Proxel brands. Examples which may be mentioned are: 1,2-benzisothiazolin-3-one (BIT) (commercially obtainable as Proxel® brands from Avecia Lim.) and its alkali metal salts; other suitable biocides are 2-methyl-2H-isothiazol-3-one (MIT) and 5-chloro-2-methyl-2H-isothiazol-3-one (CIT).

In one embodiment of the present invention, the printing formulation used in step (a) comprises up to 30% by weight of auxiliary (e), based on the sum total of metal powder, binder, emulsifier and if appropriate rheology modifier.

In one embodiment of the present invention, one or more thermal treating steps (d) can be carried out following step (a), following step (b) or following the optional step (c). Thermal treating steps carried out immediately after step (a) are also referred to as thermal treating steps (d1), thermal treating steps carried out immediately after step (c) are also referred to as thermal treating steps (d2) and thermal treating steps carried out after step (b) are also referred to as thermal treating steps (d3) in the context of the present invention.

When two or more thermal treating steps are to be carried out, the various thermal treating steps can be carried out at the same temperature or preferably at different temperatures.

Treatment temperatures in step (d) or each individual step (d) may range for example from 50 to 200° C. Care must be taken to ensure that the thermal treatment according to step (d) does not cause the material of which the covering layer (D) used as starting material consists to soften or even melt. The temperature is thus kept below the softening or melting point of the covering layer (D) in question, or the thermal treatment is kept too short for softening or even melting to take place.

Treatment duration in step (d) or each individual step (d) may range for example from 10 seconds to 15 minutes and preferably from 30 seconds to 10 minutes.

Particular preference is given to treating in a first step (d1) at temperatures in the range of for example 50 to 110° C. for a period of 30 seconds to 3 minutes and in a second step (d2), subsequently, at temperatures in the range from 130° C. to 200° C. for a period of 30 seconds to 15 minutes.

Step (d) or each individual step (d) may be carried out in equipment known per se, for example in atmospheric drying cabinets, tenters or vacuum drying cabinets.

In one preferred embodiment of the present invention, a further step (e) is carried out before step (c). Step (e) is carried out by depositing on some locations on the textile surface provided with metal powder (a) according to step (a) a mixture which likewise comprises a metal in preferably powder form which can be different from metal powder (a) or preferably is the same.

One embodiment of the process of the present invention comprises depositing in step (e), at two or more printed locations, a mixture likewise comprising metal powder (a). The mixture likewise comprising metal powder (a) may comprise further printing formulation and in particular print paste as also used in step (a), or else a mixture comprising further constituents. In a third embodiment of step (e), the mixture likewise comprising metal powder (a) comprises a preparation comprising soldering tin.

In one embodiment of the present invention, sufficient mixture comprising metal is deposited in step (e) such that the layer thickness of metal is in the range from 2 to 200 times as thick as the layer thickness of metal powder (a).

In one embodiment of the present invention, sufficient mixture comprising metal powder (a) is deposited in step (e) such that the layer thickness of metal powder (a) on decor layer (A) or part of decor layer (A) is in the range from 0.1 to 5 mm.

In one embodiment of the present invention, metal powder (a) from step (a) differs from metal powder (a) from step (e), preferably in the average particle diameter.

In one preferred embodiment of the present invention, metal powders (a) from step (a) and step (e) are each the same.

One embodiment of the present invention comprises performing so-called “dot printing”.

After step (e) has been carried out, step (d) can be repeated. However, it is preferable to dispense with a thermal treatment (d) immediately after the performance of step (e) and immediately to carry out step (c) instead.

The present invention further provides for the use of inventive multilayered articles for interior decoration of buildings or vehicles. Vehicles comprise aircraft, watercraft such as ships in particular, track vehicles and particularly automobiles. Interior decoration of buildings comprises in particular floors, walls and ceilings of buildings.

The present invention further provides buildings and vehicles comprising at least one inventive multilayered article.

The invention is elucidated by working examples.

### WORKING EXAMPLES

% ages are always % by weight, unless expressly stated otherwise.

I. Production of a Cellulose Fiber Substrate (B.1)

I.1 Production of Liquid Colorant Preparations

I.1.1 Production of a Red Liquid Colorant Preparation

A stirred ball mill was used to grind

26% by weight of C.I. Pigment Red 48:2

5% by weight of C.I. Direct Red 80

24% by weight of a 26% aqueous solution of an acrylic acid-styrene copolymer, fully ammonia neutralized, acid number: 216 mg KOH/g, average molecular weight Mₙ of 9200 g/mol

5% by weight of dipropylene glycol

40% by weight of water

together to obtain a red liquid colorant preparation.

I.1.2 Production of a Green Liquid Colorant Preparation

A mixture was prepared from 25% by weight of a green pigment preparation obtained by wet grinding in a stirred ball mill of

40% by weight of C.I. Pigment Green 7

8% by weight of a block copolymer based on ethylenediamine/propylene oxide/ethylene oxide having an ethylene oxide content of 40% and an average molecular weight Mₙ of 6500 g/mol

15% by weight of dipropylene glycol

37% by weight of water

and with 7% by weight of a 47% by weight solution of C.I. Basic Green 7 in 48% by weight of acetic acid and 68% by weight of water.

I.1.3 Conductive Liquid Black Colorant Preparation

A mixture was prepared from 98% by weight of a black pigment preparation obtained by wet grinding in a stirred ball mill of

20% by weight of conductive carbon black

10% by weight of a block copolymer based on ethylenediamine/propylene oxide/ethylene oxide having an ethylene oxide content of 40% by weight and an average molecular weight Mₙ of 12 000 g/mol

70% by weight of water

and also 2% by weight of a 10% solution of C.I. Basic Violet 3 in 30% acetic acid.

I.2 Production of Resin Batches

MDF board was produced using, unless otherwise stated, a resin batch recited in table 1:

TABLE 1

| Resin batch 1 | |
|---|---|
| Urea-melamine-formaldehyde resin, | 100.0 parts by weight |
| 66.5% in water | |
| Paraffin dispersion, 60% in water | 4.0 parts by weight |
| Colorant preparation from I.1.1 | 4.7 parts by weight |
| Water | 49.6 parts by weight |
| Solid resin content of resin batch | 42% |
| Solid resin/bone-dry fibers | 14% |
| Resin batch 1 per 100 kg of bone-dry | 33.3 kg |
| fibers | |
| Resin batch 2 | |
| Urea-melamine-formaldehyde resin, | 100.0 parts by weight |
| 66.5% in water | |
| Paraffin-dispersion, 60% in water | 4.0 parts by weight |
| Colorant preparation from I.1.2 | 2.4 parts by weight |
| Water | 52.0 parts by weight |
| Solid resin content of resin batch | 42% |
| Solid resin/bone-dry fibers | 14% |
| Resin batch 2 per 100 kg of bone-dry | 33.3 kg |
| fibers | |

I.3 Production of Substrates (B.1) to (B.2)

I.3.1 Production of Red Substrate (B.1)

33.3 kg of resin batch 1 were added to 100 kg (bone-dry) of bleached, ground and dried wood fibers based on spruce wood, followed by mixing in a drum mixer to obtain resinated red wood fibers. These resinated red wood fibers were subsequently dried in a dryer to a moisture content of about 8% by weight, poured to form a mat, predensified and pressed at 220° C. to form an MDF board. The moisture content of the MDF board thus obtained was 2% by weight.

The resulting MDF board (B.1) displays a homogeneous, brilliant, lightfast red coloration.

I.3.2 Production of a Green MDF Board

33.3 kg of resin batch 2 were added to 100 kg (bone-dry) of bleached, ground and dried wood fibers based on spruce wood, followed by mixing in a drum mixer to obtain resinated green wood fibers. These resinated green wood fibers were subsequently dried in a dryer to a moisture content of about 8% by weight, poured to form a mat, predensified and pressed at 220° C. to form an MDF board. The moisture content of the MDF board thus obtained was 2% by weight.

The resulting MDF board (B.2) displays a homogeneous, brilliant, lightfast green coloration.

II. Production of Part of a Decor Layer (A.1) Printed with a Metal Layer (C.1)

II.1 Production of a Print Paste

The following were stirred together:

54 g of water

750 g of carbonyl iron powder, d₁₀ 3 μm, d₅₀ 4.5 μm, d₉₀ 9 μm, passivated with a microscopically thin iron oxide layer.

125 g of an aqueous dispersion, pH 6.6, solids content 39.3% by weight, of a random emulsion copolymer of

1 part by weight of N-methylolacrylamide, 1 part by weight of acrylic acid, 28.3 parts by weight of styrene, 69.7 parts by weight of n-butyl acrylate, parts by weight all based on total solids, weight average particle diameter 172 nm, determined by Coulter Counter,

T_{g}: −19° C. (binder 1)

dynamic viscosity (23° C.) 70 mPa·s,

20 g of compound of the formula

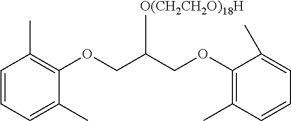

20 g of a 51% by weight solution of a reaction product of hexamethylene diisocyanate with n-C₁₈H₃₇(OCH₂CH₂)₁₅OH in isopropanol/water (2:3 by volume)

This was followed by stirring for 20 minutes at 5000 rpm (Ultra-Thurrax) to obtain a print paste having a dynamic viscosity of 30 dPa·s at 23° C., measured with a Haake rotary viscometer.

II.2 Printing of Part of Decor Layer (A.1), Providing with a Mixture Comprising Metal Powder (a1)

Print paste from 1.4 was used to print a fibrous nonwoven polyester web, basis weight 90 g/m²—with a mesh 80 sieve with a stripy pattern.

This was followed by drying in a drying cabinet for 10 minutes at 100° C. to obtain printed and thermally treated fibrous nonwoven polyester web.

II.3 Providing with a Mixture Comprising Metal Powder (a1), Step (c.1), and Fixing of Items Requiring Electric Current, Step (c)

Print paste from I. was again applied by printing, in the form of small circles having a diameter of 2 mm, onto the above-printed pattern.

Subsequently, light-emitting diodes of the type “Everlight model 67-22SURSYGC S530-A2/TR8 device number: DSE-672-025 from Everlight Electronics Co., Ltd. in red and green (SUR Type AlGaInP for red light-emitting diodes, SYR Type AlGaInP for yellow light-emitting diodes), format: 3.2 mm·2.7 mm, were distributed by hand.

Printed and thermally treated fibrous nonwoven polyester web was obtained.

III. Deposition of Copper without External Source of Current

Printed and thermally treated fibrous nonwoven polyester web from II was treated for 10 minutes in a bath (room temperature) having the following composition:

1.47 kg of CuSO₄.5H₂O

382 g of H₂SO₄

5.1 l of distilled water

1.1 g of NaCl

5 g of C₁₃/C₁₅-alkyl-O-(EO)₁₀(PO)₅—CH₃

(EO: CH₂—CH₂—O, PO: CH₂—CH(CH₃)—O)

The fibrous nonwoven polyester web was removed, rinsed twice under running water and dried at 90° C. for one hour.

This gave a part of decor layer (A.1) printed with a metal layer (C.1).

IV. Production of an Inventive Multilayered Article

IV.1 Production of MSK.1

The part of decor layer (A.1) printed with a metal layer (C.1), from III, was drenched with an aqueous impregnating liquor consisting of

1000 g of a 60% by weight urea-melamine-formaldehyde resin solution

3.5 g of a 60% by weight aqueous solution of morpholinium-para-toluenesulfonate

71 g of water,

with the aid of a wire blade.

This was followed by drying for 3 minutes at 120° C. to a residual moisture content of 3%. The basis weight was now 170 g/cm².

Thereafter, part of decor layer (A.1) printed with a metal layer (C.1) and impregnated with urea-melamine-formaldehyde resin was placed onto a substrate with the printed side down onto (B.1), followed by pressing at a temperature of 180° C. and a pressure of 25 bar for a period of 40 seconds.

This gave an inventive multilayered article MSK.1, which was provided with a groove by milling.

IV.1 Production of MSK.2

The part of decor layer (A.1) printed with a metal layer (C.1), from III, was drenched with an aqueous impregnating liquor consisting of

1000 g of a 60% by weight urea-melamine-formaldehyde resin solution

3.5 g of a 60% by weight aqueous solution of morpholinium-para-toluenesulfonate

71 g of water,

with the aid of a wire blade.

This was followed by drying for 3 minutes at 120° C. to a residual moisture content of 3%. The basis weight was now 170 g/cm².

Thereafter, part of decor layer (A.1) printed with a metal layer (C.1) and impregnated with urea-melamine-formaldehyde resin was placed onto a substrate with the printed side down onto (B.2), followed by pressing at a temperature of 180° C. and a pressure of 25 bar for a period of 10 seconds.

This gave an inventive multilayered article MSK.2, which was provided with a groove by milling.

MSK.1 and MSK.2 each have no backer.

IV.3 Performance Testing of MSK.1 and MSK.2

The production of MSK.1 and MSK.2 was repeated a multiple number of times.

A floor was produced from 20 pieces of MSK.1.

A floor was produced from 20 pieces of MSK.2.

1. A multilayered article, comprising:
(A) at least one decor layer,
(B) at least one substrate comprising at least one cellulose fiber,
(C) at least one metal-containing layer prepared by a process comprising
(a) printing the decor layer (A) or a part of the decor layer (A) with a printing formulation comprising at least one metal powder comprising a first metal, by printing at least the part of decor layer (A), with the printing formulation comprising the metal powder (a) and not other areas,
(b) depositing at least one second metal, and
(D) optionally at least one covering layer.

2. The multilayered article according to claim 1, wherein the layer (C) is prepared by the process further comprising
(c) providing with at least one item generating or consuming electric current.

3. The multilayered article according to claim 1 wherein the layer (C) is prepared by the process further comprising
(d) thermally treating the multilayered article.

4. The multilayered article according to claim 1, wherein the substrate (B) is selected from the group consisting of MDF and HDF.

5. The multilayered article according to claim 1, wherein the substrate (B) is a through-colored MDF or HDF.

6. The multilayered article according to claim 1, wherein the covering layer (D) comprises a textile, a plastic film/sheet or a paper.

7. The multilayered composite article according to claim 1, wherein the decor layer (A) comprises a decor paper or a layered product.

8. The multilayered article according to claim 1, wherein at least one item requiring or generating electric current is selected from the group consisting of at least one light-emitting diode, at least one liquid crystal display element, at least one Peltier element, at least one transistor, at least one electrochromic dye, at least one electromechanical element, and at least one solar cell.

9. A process for producing a multilayered article, comprising:
(a) printing at least a part of a decor layer (A), with a printing formulation comprising at least one metal powder comprising a first metal and not other areas,
(c) optionally providing at least one item generating or consuming electric current,
(b) depositing a second metal,
(d) optionally treating thermally the multilayered article,
and applying the decor layer (A) to at least one substrate (B) comprising at least one cellulose fiber to produce a metal-containing layer (C),
optionally providing with a covering layer (D) on the decor layer (A), the at least one substrate (B), or the metal-containing layer (C).

10. The process according to claim 9, wherein no external source of voltage is applied in the depositing the second metal and the second metal in the depositing the second metal has a stronger positive standard potential in an electrochemical series of elements than the first metal in the metal powder printed in the printing the decor layer (A).

11. The process according to claim 9, wherein an external source of voltage is applied in the depositing the second metal and the second metal in the depositing the second metal has a stronger or weaker positive standard potential in the electrochemical series of the elements than the first metal in the metal powder (a) printed in the printing the decor layer (A).

12. The process according to claim 9, wherein the metal powder in the printing the decor layer (A) comprises a metal powder obtained by thermal decomposition of iron pentacarbonyl.

13. The process according to claim 9, wherein the printing the decor layer (A) employs the printing formulation to print at least a pattern and the metal powder is arranged in the form of a straight or a bent stripy pattern or a line pattern.

14. The process according to claim 9, wherein a multilayered article is produced.

15. A method for decorating an interior of a building or an interior of a vehicle, comprising:
arranging at least one multilayered article according to claim 1 to the interior of the building or the interior of the vehicle.
